(19) United States
(12) Patent Application Publication
(10) Pub. No.: US 2020/0103356 A1
(43) Pub. Date: Apr. 2, 2020

(54) DEVICE AND METHOD FOR INSPECTING A FILTRATION UNIT

(71) Applicant: Tetra Laval Holdings & Finance S.A., Pully (CH)

(72) Inventors: Todd Hutson, Ramsey, MN (US); Timothy Eilrich, Elk River, MN (US); Andrew Bongard, Waconia, MN (US)

(21) Appl. No.: 16/492,113

(22) PCT Filed: Mar. 10, 2017
(86) PCT No.: PCT/US2017/021744

§ 371 Date: Sep. 7, 2019

(51) Int. Cl. G01N 21/954; B01D 35/143; G03B 37/00

(52) U.S. Cl. CPC G01N 21/954; B01D 35/143; G01N 2021/9542; B01D 2221/06; G03B 37/005

(57) ABSTRACT

A filtration unit inspection device including an image capturing device for generating image data, an operator unit for presenting the image data, and a data cable connecting the image capturing device to the operator unit, the image capturing device and at least part of the data cable being adapted to be fed into a filtration unit, wherein the filtration unit inspection device includes a guiding element that is provided on the image capturing device for facilitating feeding the image capturing device through the filtration unit.

### TECHNICAL FIELD

The present patent application relates to filtration unit inspection devices and methods for inspecting filtration units.

### BACKGROUND ART

During recent years it has been increasingly popular to use filtration technology for processing milk and other beverages. The filtration technology is for example used for removing lactose from milk based products, or for separating protein from milk based products. Having the possibility to separate milk components by filtration enables dairies to offer new types of products, such as lactose-free milk or protein enriched milk. In addition to being able to offer new types of products, or being able to produce existing value added milk products more efficiently by using filtration technology, dairies are also enabled to increase a quality consistency of their milk products, since being able to separate the milk into its different components provides the opportunity to decrease a variance between different batches of milk. Another positive effect of using filtration technology for processing milk products is that the different components of the milk can be separated to a higher degree. For instance, instead of providing lactose-reduced milk a dairy using modern filtration technology is able to produce lactose-free milk or near lactose-free milk, with significantly lower lactose content than the lactose reduced milk, which of course is of interest for consumers suffering from lactose intolerance.

In order to make sure that filtration units are performing according to set requirements, it is today common practice to take product samples and analyze these at regular intervals. In case an analysis of a product sample shows that it is out of set requirement ranges, production is stopped such that a service technician can investigate the filtration unit in order to find out why it is not performing as expected. Having to stop the production has a negative impact on production economy, and it is therefore of interest for dairies and other food processing companies to mitigate production stops or at least keeping them as short as possible.

In addition to avoiding production stops, it is further of interest to be able to identify why the filtration unit is not performing as expected. Being able to do so provides for that fewer parts of the unit must be replaced.

Thus, analyzing the performance of filtration units by taking and analyzing product samples provides in many cases good quality control, but often fails to provide information in respect of why the filtration unit is not performing as expected. Not knowing why the unit is not performing as expected may result in long periods of production stop as well as unnecessary replacement of equipment parts.

### SUMMARY

It is an object of the invention to at least partly overcome one or more of the above-identified limitations of the prior art. In particular, it is an object to efficiently identify why a filtration unit is not performing as expected.

According to a first aspect it is provided a filtration unit inspection device comprising an image capturing device for generating image data, an operator unit for presenting the image data, and a data cable connecting the image capturing device to the operator unit, the image capturing device and at least part of the data cable being adapted to be fed into a filtration unit, wherein the filtration unit inspection device comprises a guiding element that is provided on the image capturing device for facilitating feeding the image capturing device through the filtration unit.

The guiding element may comprise a main element provided on the image capturing device, and a cage attached to the main element.

The filtration unit inspection device may include a number of other features, alone or in combination. For example, the main element may be sleeve-shaped and provided around the image capturing device, the cage may be provided with a curved top, the cage may comprise at least two arc-shaped elements, the main element may have a width in the range of 5 to 40 mm, and the main element may be provided with beveled surfaces.

The filtration unit may be configured to filter liquid food products. The filtration unit may be a spiral wound membrane filtration unit. In detail, the filtration unit may comprise at least one membrane element that has a permeate tube, wherein the image capturing device, the guiding element and at least part of the data cable are arranged to be fed into the permeate tube.

The filtration unit may comprise a first interconnector that connects a first part of the permeate tube to a second part of the permeate tube, wherein the image capturing device, the guiding element and at least part of the data cable are arranged to be fed through the first interconnector.

According to a second aspect it is provided a method for inspecting a filtration unit with a filtration unit inspection device according the first aspect, the filtration unit comprising at least one membrane element that has a permeate tube, the method comprising feeding the guiding element, the image capturing device and at least part of the data cable into the permeate tube, capturing image data depicting an inside of the filtration unit, transmitting the image data from the image capturing device to the operator unit, and presenting the image data via the operator unit.

The method may further comprise feeding the image capturing device, the guiding element and at least part of the data cable through a first interconnector that connects a first part of the permeate tube to a second part of the permeate tube.

The image capturing device may be fed into the permeate tube in a direction opposite to a permeate flow direction. An advantage lies in that the image capturing device may be fed into the permeate tube during operation of the filtration unit.

Still other objectives, features, aspects and advantages of the invention will appear from the following detailed description as well as from the drawings.

### BRIEF DESCRIPTION OF THE DRAWINGS

Embodiments will now be described, by way of example, with reference to the accompanying schematic drawings, in which

FIG. 1 is a cross-sectional view of a filtration unit,

FIG. 2 is a schematic view of a filtration unit inspection device, FIGS. 3a, 3b and 3c are perspective, top and side views of a guiding element of the filtration unit inspection device of FIG. 2, and

FIG. 4 is a flowchart illustrating a method for inspecting a filtration unit.

### DETAILED DESCRIPTION

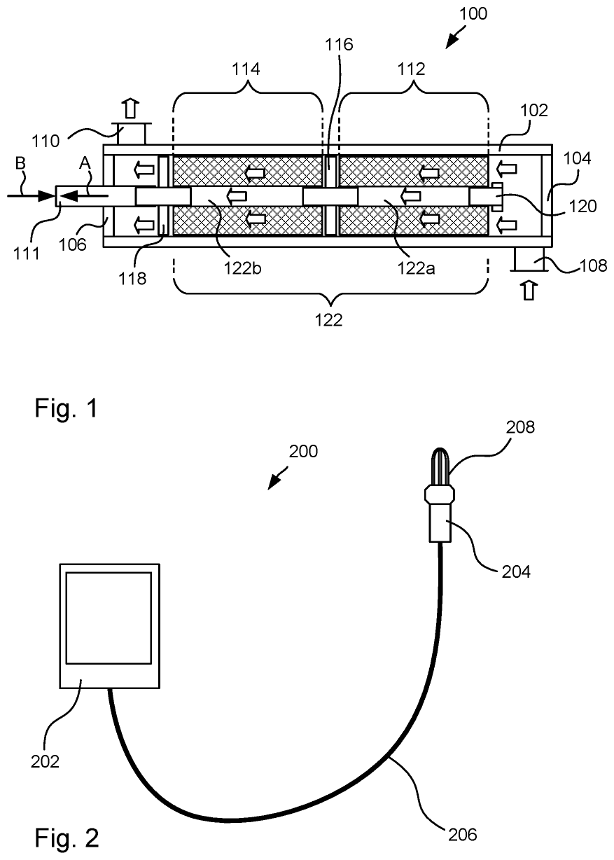

With reference to FIG. 1 a cross-sectional view of an example of a filtration unit 100 is illustrated. The filtration unit 100 comprises a membrane housing 102 that in a first end is provided with a first end cap 104 and in a second end is provided with a second end cap 106. A feed solution, such as milk or other food product, may be fed into the filtration unit 100 via a feed inlet 108, a retentate, sometimes also referred to as concentrate, may be fed out from the filtration unit 100 via a retentate outlet 110, and a permeate may be fed out from the filtration unit 100 via a permeate outlet 111.

The filtration unit 100, which may be a spiral wound membrane filtration unit, may comprise a number of membrane elements. In the illustrated example a first membrane element 112 and a second membrane element 114 are used. The first membrane element 112 and the second membrane element 114 are connected to each other by a first interconnector 116. Further, in order to connect the second membrane element 114 to the permeate outlet 111, a second interconnector 118 is used. In order to close an end of the first element 112 facing away from the second membrane element 114, an end plug 120 may be used.

The membrane elements 112, 114 may each comprise a perforated central tube that is surrounded by different layers for separating the feed solution into the retentate and the permeate. These layers may comprise feed channel spacer layers, membrane layers, permeate collection layers and an outer wrap, as commonly available within the industry. In the filtration unit 100 illustrated in FIG. 1, the first membrane element 112 may comprise a first perforated central tube that forms a first part 122a of a permeate tube 122 and the second membrane element 114 may comprise a second perforated central tube that forms a second part 122b of the permeate tube 122.

The first interconnector 116 may be partly placed inside the first part 122a of the permeate tube 122 and the second part 122b of the permeate tube 122 in order to provide a flow path between the two parts 122a, 122b. In a similar manner the second interconnector 118 may be partly placed inside the second part 122b and the permeate outlet 111 in order to provide a flow path between the two.

The filtration unit 100 may be used for different applications and may use other types of filtration technologies, such as reverse osmosis, nanofiltration, microfiltration and ultrafiltration.

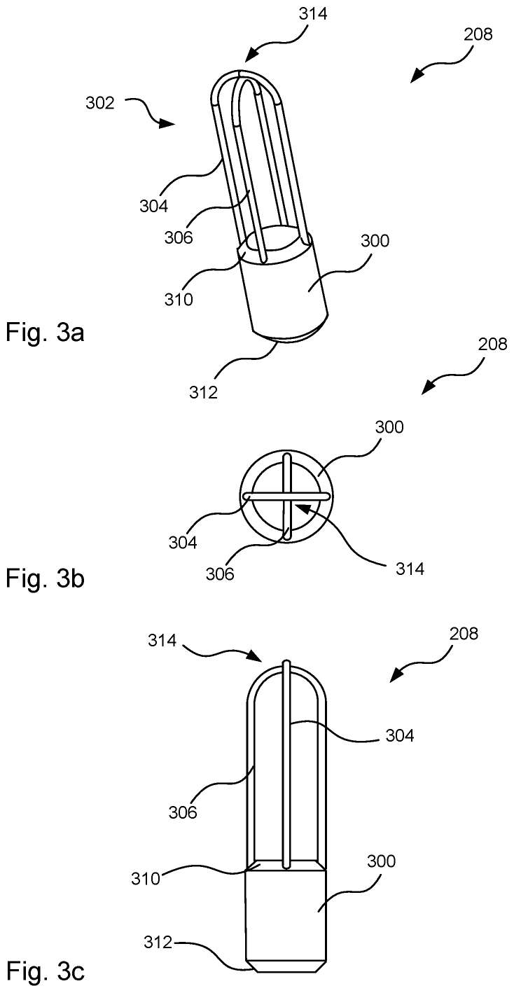

FIG. 2 illustrates a filtration unit inspection device 200 that comprises an operator unit 202, an image capturing device 204 and a data cable 206 connecting the image capturing device 204 to the operator unit 202. A guiding element 208 is provided on the image capturing device 204.

The image capturing device 208, which may be a camera, and at least part of the data cable 206 are adapted to be fed into the filtration unit 100, which implies for instance that they are waterproof. The guiding element 208 is provided on the image capturing device 204 in order to reduce a risk that the image capturing device 204 is stuck when being fed into the filtration unit 100. A risk of getting the image capturing device 204 to stuck may for instance occur when the image capturing device 204 is fed from the first part 122a to the second part 122b of the permeate tube 122 due to that the first interconnector 116 is placed partly inside the first part 122a and the second part 122b. This may imply that an inner diameter of the permeate tube 122 is smaller in the intersection area between the first part 122a and the second part 122b than in a non-intersection area of the permeate tube 122.

Even though the operator unit 202 may be provided with a screen as illustrated in FIG. 2, the operator unit 202 may also be a transmitter device that transmits image data captured by the image capturing device 204 to an external screen.

In addition to transferring the image data from the image capturing device 204 to the operator unit 202, in analog or digital form, the data cable 206 may be used by a user for directing the image capturing device 204 inside the filtration unit 100. Thus, the data cable 206 may have a stiffness suitable for this purpose. The operator unit 202, the image capturing device 204 and the data cable 206 may have the form of any suitable, commercially available combination of operator unit, image capturing device and data cable, such as the Waterproof Recording Video Inspection Camera/Borescope provided by General Tools & Instruments LLC.

The guiding element 208 is illustrated in further detail in FIGS. 3a, 3b and 3c and comprises a main body 300 that is provided onto (attached to) the image capturing device 204. The main body 300 is sleeve-shaped, as illustrated, and is arranged such that a tight fit with the image capturing device 204 is achieved. This is accomplished by giving the main body 300 an inner diameter that is smaller than the outer diameter of the image capturing device 204, and by pressing the main body 300, which is made of a slightly flexible, plastic material, over the image capturing device 204 so that it fits tightly thereon. Thus, no locking mechanisms are needed for keeping the image capturing device 204 and the guiding element 208 together during use. Even though the main body 300 is illustrated as a sleeve shaped body with circular cross section, any shape of the main body 300 coinciding with a shape of the image capturing device 204 may be used. Alternatively, instead of adapting the shape of the main body 300 to a shape of the image capturing device 204, the main body 300 may be provided with one or several locking mechanisms for ensuring that the guiding element 208 and the image capturing device 204 are securely attached to each other.

A cage 302 is attached to the main body 300 for facilitating feeding of the image capturing device 204 into a filtration unit like the filtration unit 100 illustrated in FIG. 1. The cage 302 may be arranged in different ways. As illustrated the cage 302 may comprise two arc-shaped elements 304, 306 that are attached to the main body 300. The arc-shaped elements 304, 306 may be attached by providing holes in the main body 300 and by inserting outer ends of the arc-shaped elements 304, 306 into these holes.

The main body 300 is in its end portions provided with beveled surfaces 310, 312. The beveled surfaces 310, 312 may be inclined 30 to 70 degrees with respect to a non-beveled outer, cylindrical surface of the main body 300. The beveled surfaces 310,312 provide for easier handling of the filter unit inspection device 200 when an operator feeds the guiding element 208 and the image capturing device 204 into a filtration unit 100.

In order to further reduce the risk that the guiding element 208 gets stuck when being fed into the filtration unit 100, the cage 302 may be provided with a curved top 314. The curved top 314 may be a convex top that is accomplished by using arc-shaped elements 304, 306 as illustrated.

A width of the guiding element 208 is typically less than the inner diameter(s) of the first interconnector 116 and the second interconnector 118, such that the guiding element 208 can pass through the interconnectors 116, 118 when being fed into the filtration unit 100. The main body may have a width in the range of 5 to 40 mm. A length of the main body 300 may be in the range of 1 to 4 cm, and the cage 302 may have a length in the range of 1 to 7 cm. The arc-shaped elements 304, 306 may be made of metal and may have a diameter of 5 to 40 mm.

To attach the guiding element 208 to the image capturing device 204 the image capturing device 204 is pressed into the main element 300 at the side where the beveled surface 312 is located. The image capturing device 204 is then fed further into the main element 300 until the front side (typically a lens) of the image capturing device 204 is aligned with the side of the main element 300 where the beveled surface 310 is located.

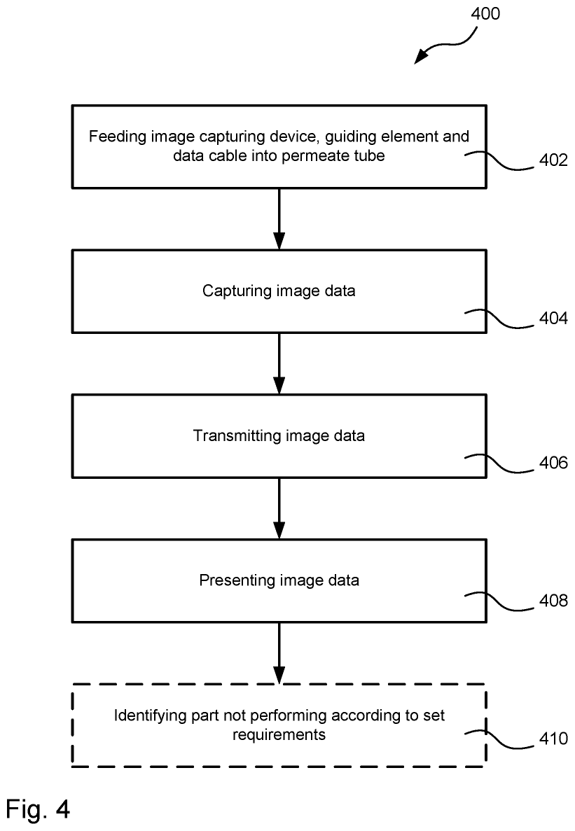

With reference to FIG. 4 a flowchart 400 is illustrated, comprising steps of a method for inspecting the filtration unit 100. The method is typically applied for a filtration unit that filters liquid food, i.e. the filtration unit 100 may operate as a liquid food filtration unit.

In a first step 402, the guiding element 208, the image capturing device 204 and at least part of the data cable 206 is be fed into the filtration unit 100. The guiding element 208, the image capturing device 204 and the at least part of the data cable 206 is typically fed into the permeate tube 122 via the permeate inlet 111, in a direction B opposite to a permeate flow direction A. The permeate flow direction A is the direction by which the permeate is intended to flow when the filtration unit 100 is operated. Thus, the guiding element 208, the image capturing device 204 and the at least part of the data cable 206 may be fed into the permeate tube 122 during operation of the filtration unit 100, i.e. when liquid food product is fed into the filtration unit 100 and retentate and permeate are fed out from the filtration unit 100. The liquid food may be dairy products such as milk, or milked based products such as whey.

Further, the guiding element 208, the image capturing device 204 and the at least part of the data cable 206 are arranged to be fed through the first and the second interconnector 116, 118, when the filtration unit 100 includes such interconnectors.

In a second step 404 of the method image data depicting an inside of the filtration unit 100 is captured.

In a third step 406 the image data is transmitted from the image capturing device 204 to the operator unit 202.

In a fourth step 408 the image data is presented via the operator unit, either on a screen provided on the operator unit 202 or on an external screen (not shown) that is operatively connected to the operator unit 202.

Optionally, in a fifth step 410, the image data may, by implementing conventional image processing algorithms, be processed by a data processing device in order to automatically determine discrepancies between the image data and reference image data such that parts not performing to set requirements may be identified. Set requirements represent a condition where the filtration unit 100 operates as intended. For instance, in a milk filtration application, if identifying white colored liquid in the first part 122a of the permeate tube 122, the first part 122a may be identified as the part not performing according to set requirements, since it is known that the permeate shall be a clear liquid. In this case the first membrane element 112 comprising the first part 122a may be identified to be replaced.

The step of feeding 402 the guiding element 208, the image capturing device 204 and at least part of the data cable 206 into the filtration unit 100 is typically done by an operator that shall inspect the filtration unit 100. Steps 404, 406 and 408 are performed by the filtration unit inspection device 200 and may be inherent functions of the filtration unit inspection device 200.

In practice, the guiding element 208, the image capturing device 204 and at least part of the data cable 206 may, when the filtration unit 100 is operating, be fed into the filtration unit 100 by disconnecting the permeate outlet 111 from a piping component (not shown) that receives the permeate from the permeate outlet 111. The guiding element 208, image capturing device 204 and data cable 206 may then be fed into the permeate outlet 111 and further into the permeate tube 122 where image data can be captured. This will lead to some spilling of the permeate, which may easily be cleaned up. To avoid or at least reduce spilling of permeate, a dedicated inlet for the guiding element 208, image capturing device 204 and data cable 206 may be arranged in the side of the permeate outlet 111, at a section of the permeate outlet 111 that is located outside the membrane housing 102. The dedicated inlet is during normal operation sealed by a plug, which can be removed for allowing insertion of the guiding element 208, image capturing device 204 and data cable 206, and has a diameter that is just big enough to let in the guiding element 208, image capturing device 204 and data cable 206. To reduce spilling of permeate even further, the edges of the dedicated inlet may be provided with a flexible lining that allows passage of the guiding element 208 and the image capturing device 204, while fitting snugly around the data cable 206 such that permeate spilling is minimized.

The step 410 of identifying parts of the filtration unit that does not perform according to set requirements may be performed by an operator that views the presented image data and, based on what the image shows and on empirical knowledge, determines which part of the filtration that does not perform as intended. From the description above follows that, although various embodiments of the invention have been described and shown, the invention is not restricted thereto, but may also be embodied in other ways within the scope of the subject-matter defined in the following claims.

1. A filtration unit inspection device comprising:
an image capturing device for generating image data,
an operator unit for presenting the image data, and
a data cable connecting the image capturing device to the operator unit,
the image capturing device and at least part of the data cable being adapted to be fed into a filtration unit,
wherein the filtration unit inspection device comprises
a guiding element that is provided on the image capturing device for facilitating feeding the image capturing device through the filtration unit.

2. The filtration unit inspection device according to claim 1, wherein the guiding element comprises:
a main element provided on the image capturing device, and
a cage attached to the main element.

3. The filtration unit inspection device according to claim 2, wherein the main element is sleeve-shaped and provided around the image capturing device.

4. The filtration unit inspection device according to claim 2, wherein the cage is provided with a curved top.

5. The filtration unit inspection device according to claim 2, wherein the cage comprises at least two arc-shaped elements.

6. The filtration unit inspection device according to claim 2, wherein the main element has a width in the range of 5 to 40 mm.

7. The filtration unit inspection device according to claim 2, wherein the main element is provided with beveled surfaces.

8. The filtration unit inspection device according to claim 1, wherein the filtration unit is configured to filter liquid food products.

9. The filtration unit inspection device according to claim 1, wherein the filtration unit is a spiral wound membrane filtration unit.

10. The filtration unit inspection device according to claim 1, wherein the filtration unit comprises at least one membrane element that has a permeate tube, wherein the image capturing device, the guiding element and at least part of the data cable are arranged to be fed into the permeate tube.

11. The filtration unit inspection device according to claim 10, wherein the filtration unit comprises a first interconnector that connects a first part of the permeate tube to a second part of the permeate tube, wherein the image capturing device, the guiding element and at least part of the data cable are arranged to be fed through the first interconnector.

12. A method for inspecting a filtration unit with a filtration unit inspection device according to claim 1, the filtration unit comprising at least one membrane element that has a permeate tube, the method comprising:
feeding the guiding element, the image capturing device and at least part of the data cable into the permeate tube,
capturing image data depicting an inside of the filtration unit,
transmitting the image data from the image capturing device to the operator unit, and
presenting the image data via the operator unit.

13. The method according to claim 12, comprising feeding the image capturing device, the guiding element and at least part of the data cable through a first interconnector that connects a first part the permeate tube to a second part of the permeate tube.

14. The method according to claim 12, wherein the image capturing device is fed into the permeate tube in a direction that is opposite to a permeate flow direction.

15. The method according to claim 12, wherein the image capturing device is fed into the permeate tube during operation of the filtration unit.
